(19) United States
(12) Patent Application Publication
(10) Pub. No.: US 2025/0382440 A1
(43) Pub. Date: Dec. 18, 2025

(54) POLYOXMETHYLENE POLYMER INCORPORATING AN ALDEHYDE SCAVANGER

(71) Applicant: Colormatrix Holdings, Inc., Avon Lake, OH (US)

(72) Inventors: Christopher STARKIE, Knowsley (GB); Chen CHEN, Singapore (SG)

(21) Appl. No.: 18/878,738

(22) PCT Filed: Jun. 3, 2023
(86) PCT No.: PCT/IB2023/055731

§ 371 Date: Dec. 24, 2024

(30) Foreign Application Priority Data
Jun. 29, 2022 (GB) 2209526.9

(51) Int. Cl. C08K 5/20; B29B 9/02; B29K 59/00; C08J 3/20; C08J 3/22; C08K 5/134; C08K 5/315

(52) U.S. Cl. CPC C08K 5/20; B29B 9/02; C08J 3/203; C08J 3/226; C08K 5/134; C08K 5/315; B29K 2059/00; C08J 2359/02

(57) ABSTRACT

A method of decreasing aldehyde content in a polyoxymethylene (POM) polymer, increasing Oxidative Induction Time (OIT) and/or increasing thermal stability comprises contacting the POM polymer with an aldehyde scavenger selected from: (i) a compound XX which includes at least three moieties of formula (AA) wherein each moiety (AA) includes an amine moiety (—NH2) bonded ortho or meta to the amide moiety (—CONH), each R¹ independently represents a substituent and m is an integer from 0 to 4; and the three moieties (AA) are bonded, via their respective amide nitrogen atoms, to respective carbon atoms of a Main Fragment, wherein the Main Fragment includes carbon and hydrogen atoms only and is saturated; and (ii) a cyanoacetamide.

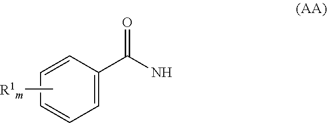

This invention relates to polymeric materials and particularly, although not exclusively, relates to polyoxymethylene (POM) in which aldehyde may undesirably be associated, for example by virtue of being produced during manufacture of the polymeric material, during downstream melt-processing of the polymeric materials and/or during use thereof.

Polyoxymethylene (POM) is also called acetal, polyacetal, or polyformaldehyde. It is a polymer with a linear ether structure (CH₂O—)n along its backbone. This linearity leads to a high crystallization degree that can be up to 80%, and density of 1.410-1.420 g/cm3. In some cases, POM may be filled, for example with glass fibres or carbon fibres.

POM finds increasing use in numerous applications, including electrical and electronics, consumer products, automotive and industrial machinery, medical devices, building and construction.

POM may be sold as a copolymer or a homopolymer. Homopolymer POM has the structure

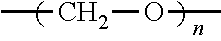

It consists essentially of the aforementioned repeat unit.

Copolymer POM includes the following repeat units:

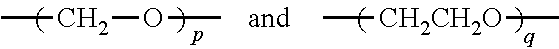

It consists essentially of the aforementioned repeat units.

Both homo and copolymer POM use methanol as the major basic raw material. For POM homopolymers, formaldehyde is synthesized through air oxidation of methanol, followed by formation of acetal resins by using ionic initiators. Replacement of the hydroxyl groups on polymer chain ends by ester groups stabilizes the resins in POM homopolymers. POM copolymers in general are produced using trioxane as the raw material (also produced starting from methanol). Around 2-3% epoxy-compounds are copolymerized with the trioxane to provide a stable POM copolymer. Chain end-capping may also be used. POM copolymer resin has greater stability but reduced crystallinity as a result of carbon-carbon bonded groups interspersed in its polymer chain. This polymer structure also imparts superior resistance to alkali, hot water, and other chemicals, as well as long life at elevated temperatures and more latitude in processing conditions. On the other hand, its tensile strength, rigidity, softening point and melting point are all lower than those found in the acetal homopolymer.

Polyoxymethylene (POM) is inherently unstable and prone to polymer degradation. POM degradation occurs via chain scission or end group decomposition. Common degradation products are formaldehyde, formic acid, cyclic acetals and oligomers. Melt processing of POM causes degradation of the polymer leading to the generation of formaldehyde. Formaldehyde emissions lead to challenges in workplace safety during polymer processing and restrict the use of the polymer in applications where air quality is critical such as automotive applications.

Formaldehyde generated by polymer degradation can oxidise to formic acid, contributing to the hydrolysis of the polymer chain. Aside from formaldehyde emissions, POM degradation leads to mold deposits, reduction in mechanical properties and discoloration.

POM resins may also be sensitive to acid hydrolysis by mineral acids. For example, low levels of chlorine in potable water can lead to environmental stress cracking. As such POM parts are stabilized to mitigate this degradation.

It is known to take steps to stabilise POM and reduce aldehyde emissions. For example, steps to effect stabilisation may be applied either during the final stages of POM production or during melt processing to form an article or masterbatch. Approaches to prevent POM degradation that have been developed include phenolic antioxidants to limit oxidative degradation, lubricants to reduce shear forces, acid scavengers to prevent formic acid hydrolysis, scavengers to react with free formaldehyde, use of end capping, light stabilisers and/or comonomers to improve stability.

In addition, to the problem of aldehyde generation as aforesaid, POM is susceptible to thermally induced oxidative decomposition. The relative thermo-oxidative stability of POM polymers may be assessed by measuring the Oxidative Induction Time (OIT). A relatively high OIT is preferred.

Although various kinds of stabilization packages are commercially used, it is challenging to both reduce aldehyde emissions in POM and improve its thermal stability as illustrated by an increased OIT.

It is an object of the present invention to address one or more of the above problems.

According to a first aspect of the invention, there is provided a method of decreasing aldehyde, for example formaldehyde, content in a polyoxymethylene (POM) polymer and/or increasing Oxidative Induction Time (OIT) and/or increasing thermal stability, the method comprising the step of contacting the POM polymer, or monomers, oligomers or pre-polymers involved in the preparation of said POM polymer, with an aldehyde scavenger selected from:
(i) a compound XX which includes at least three moieties of formula

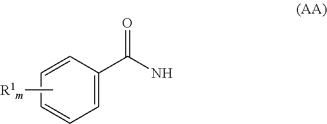

wherein each moiety (AA) includes an amine moiety (—NH₂) bonded ortho or meta to the amide moiety (—CONH);
wherein each R¹ independently represents a substituent and m is an integer from 0 to 4; and
wherein the three moieties (AA) are bonded, via their respective amide nitrogen atoms, to respective carbon atoms of a Main Fragment, wherein the Main Fragment includes carbon and hydrogen atoms only and is saturated; and
(ii) a cyanoacetamide, for example, of general formula

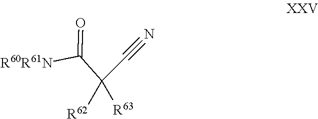

wherein R⁶⁰ and R⁶¹ independently represent a hydrogen atom or an optionally-substituted, preferably unsubstituted, alkyl, cycloalkyl or aromatic group; and
wherein R⁶² and R⁶³ independently represent a hydrogen atom or an optionally-substituted, preferably unsubstituted, alkyl, cycloalkyl or aromatic group; or R⁶² and R⁶³ together define an optionally-substituted alkenyl group.

References herein to reducing aldehyde suitably primarily refer to formaldehyde which as described is a particular problem in the context of POM.

Said method preferably decreases aldehyde content in POM, when assessed according to VDA-275. Said method suitably improves thermal stability of the POM and leads to an increased OIT which may be illustrated as described in Assessment 3.

Said POM suitably includes a —(CH₂O)— repeat unit (referred to as “repeat unit X”). It may also include a —(CH₂CH₂O)—repeat unit (referred as “repeat unit Y”). Preferably, in said POM, the sum of the mole % of repeat units X and Y is at least 80 mole %, preferably at least 90 mole %, more preferably at least 95 mole %, especially about 100 mole %.

In said POM, suitably the wt % of the POM polymer made up of repeat units X and Y is at least 80 wt %, preferably at least 90 wt %, more preferably at least 95 wt % and, especially, at least 98 wt %.

Said POM may be a homopolymer POM which suitably consists essentially of repeat units X or may be a copolymer POM which may comprise or preferably consist essentially of repeat units X and Y.

In said compound XX, one or each R¹ may be selected from a halogen atom, or an optionally-substituted hydrocarbon, alkoxy, amine, amide, phenol or carboxylic acid, group. An optionally-substituted hydrocarbon may be substituted by one or more halogen atoms or by alkoxy, amine, amide, phenol or carboxylic acid, groups. An optionally-substituted hydrocarbon is preferably un-substituted.

One or each R¹ may be an optionally-substituted, preferably an unsubstituted, alkyl group, for example an optionally-substituted, preferably an unsubstituted, C₁₋₂₀, for example C₁₋₁₀, alkyl group. R¹ may be arranged to improve the compatibility of compound XX in the polymeric material in which it may be incorporated, for example by virtue of R¹ including relevant functional groups to improve compatibility.

One or each m may be 0 or 1. Preferably, each m=0. That is, other than the amine and amide moieties, each moiety (A) is unsubstituted.

Preferably, in compound XX, at least one moiety (AA) includes an amine moiety (—NH₂) bonded ortho to the amide moiety (—CONH). Preferably in each moiety (AA) in compound XX, the amine moiety is bonded ortho to the amide moiety. Preferably, in this case, m=0.

Preferably, said Main Fragment does not include any cyclic or aromatic moiety. Preferably said Main Fragment comprises a linear or branched chain.

Said Main Fragment may include 3 to 20 carbon atoms. Preferably, it includes 5 to 15 carbon atoms, more preferably 7 to 12 carbon atoms and, especially, 8 to 10 carbon atoms. When the number of carbon atoms is n, the number of hydrogen atoms may be equal to 2n−1. Preferably, said Main Fragment includes 5 to 39 hydrogen atoms. Preferably, it includes 9 to 29 hydrogen atoms, more preferably 13 to 23 hydrogen atoms and, especially, 15 to 19 hydrogen atoms.

In a preferred embodiment, said Main Fragment is a C₉H₁₇ moiety.

Said Main Fragment may include a linear chain which includes 6 to 14 carbon atoms, preferably 6 to 10 carbon atoms. The linear chain may include a branch point to which a chain which includes 1 to 4 carbon atoms is attached.

Said Main Fragment may be of general formula

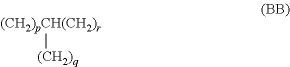

wherein p, q and r are integers, suitably in the range 1 to 10, preferably 1 to 5. Preferably, p is in the range 2 to 4, q is in the range 1 to 3 and r is in the range 2 to 6.

Preferably, the sum of integers p, q and r is at least 4, preferably at least 6, more preferably at least 7. Said sum may be less than 20, preferably less than 15, more preferably less than 10.

In compound XX, preferably the nitrogen atoms of the amide moieties (—CONH) are spaced apart by at least 2, preferably at least 4, carbon atoms; and suitably by no more than 10, for example no more than 7 carbon atoms.

Said compound XX may be of formula

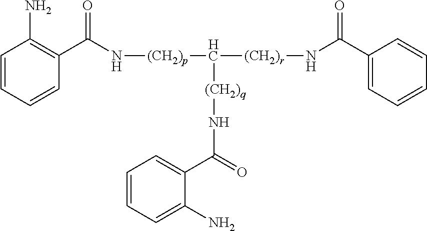

wherein p, q and r are as described above.

Said compound XX is preferably

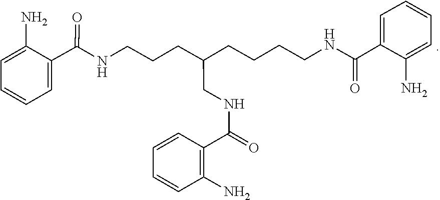 [SMILES: Nc1ccccc1C(=O)NCCCCC(CCCNC(=O)c1ccccc1N)CNC(=O)c1ccccc1N]

In a preferred embodiment of said compound of formula XXV, R⁶⁰ and R⁶¹ independently represent a hydrogen atom or an unsubstituted alkyl or cycloalkyl group and R⁶² independently represent a hydrogen atom or an unsubstituted alkyl or cycloalkyl group. In an especially preferred embodiment, R⁶⁰, R⁶¹, R⁶² and R⁶³ each represent hydrogen atoms.

A reference herein to “ppm” refers to “parts per million” by weight.

Said aldehyde scavenger may be part of a formulation which is contacted with the POM polymer. Said formulation may be a liquid or solid formulation. References to a state of a material herein (e.g. a liquid) refer to the state at standard temperature and pressure (STP).

Said formulation may include at least 50 wt % of carrier, preferably at least 60 wt %, more preferably at least 70 wt %, especially at least 75 wt %. Said formulation may include less than 95 wt % of said carrier.

Said formulation may include 50-95 wt % of a carrier, 5-50 wt % of said aldehyde scavenger and 0-30 wt % of other additives. Said other additives may be selected from colourants, antioxidants, thickeners, process stabilizers, acid scavengers, lubricants and UV additive.

Preferably, in said formulation, the sum of the wt % of carrier(s) and a said aldehyde scavenger is at least 80 wt %, at least 90 wt % or at least 95 wt %.

Said formulation may be a solid masterbatch or a liquid formulation. When it is a solid masterbatch, it may comprise 60-95 wt % of thermoplastic polymer, for example a polyoxymethylene (POM).

Said formulation may include 10-40 wt % of said aldehyde scavenger and 60-90 wt % of thermoplastic polymer, for example POM.

A solid masterbatch may include 0 to 10 wt %, preferably 0.5 to 10 wt %, of one or more antioxidants.

When said formulation is a liquid formulation, said formulation may comprise 50 to 90 wt % (for example 50 to 80 wt %) of liquid carrier and 10 to 50 wt % (for example 20 to 50 wt %) of said aldehyde scavenger. Said liquid carrier may be a liquid at STP. A carrier is suitably such that it has good solubility in the POM into which it is to be added. It may comprise an oil (e.g. vegetable or mineral oil) or a glycol.

It is found that anti-oxidant can act synergistically in the method and an anti-oxidant may be included in a said formulation, when used in the method; or may otherwise contact the POM.

The method may comprise contacting the POM with anti-oxidant. A ratio defined as the wt % of aldehyde scavenger divided by the wt % of anti-oxidant may be at least 1.0, preferably at least 3.0. Said ratio may be less than 20.0, preferably less than 10.0.

When a formulation is used in the method and/or is contacted with POM in the method, said formulation may include 0 to 10 wt % of one of more anti-oxidants. The sum of the wt % of anti-oxidants in the formulation may be in the range 0 to 10 wt %, preferably in the range 0.5 to 10 wt %, or 0.5 to 7.0 wt %. Said formulation preferably includes at least 1.0 wt % of an anti-oxidant.

Said formulation may optionally include a phosphorus-containing antioxidant (e.g., a phosphite-series compound such as triphenyl phosphite, a triphenyl phosphate-series compound such as tris(2,4-di-t-butylphenyl) phosphate, a diphosphonite-series compound, and a metal salt of hypophosphorous acid).

Said anti-oxidant may (and preferably does) comprise a sterically-hindered phenol compound.

Said anti-oxidant may include a moiety:

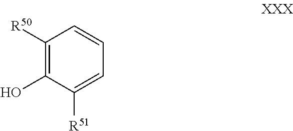

wherein R⁵⁰ and R⁵¹ independently include at least four atoms which are preferably selected from C, H, O and N atoms; and more preferably, are selected from C and H atoms. R⁵⁰ and R⁵¹ are preferably saturated. R⁵⁰ may represent a tertiary alkyl moiety, for example a tertiary alkyl moiety which includes at least 4 carbon atoms. R⁵⁰ preferably represents a t-butyl moiety. R⁵¹ may represent a C₁₋₄ alkyl moiety, especially a methyl group.

Said anti-oxidant may include at least two moieties XXX.

Said anti-oxidant may include one or more oxyalkylene moieties, for example oxyethylene moieties.

Said anti-oxidant may include one or more ester moieties.

Said anti-oxidant preferably includes C, H and O atoms only.

Said anti-oxidant may be of formula

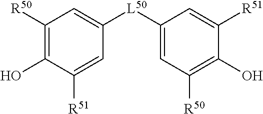

wherein L⁵⁰ is a linking moiety which suitably includes said oxyalkylene moieties and one or more ester moieties. Said anti-oxidant may be as follows:

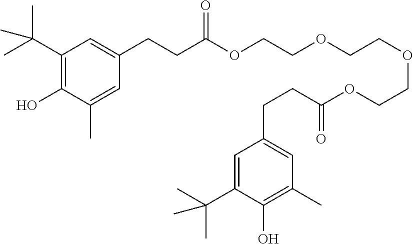 [SMILES: Cc1cc(CCC(=O)OCCOCCOCCOC(=O)CCc2cc(C)c(O)c(C(C)(C)C)c2)cc(C(C)(C)C)c1O]

Said method preferably decreases aldehyde content in the POM polymer so the POM polymer includes 2 ppm or less of aldehyde when assessed according to VDA-275. It also suitably increases OIT.

According to a second aspect of the invention, there is provided the use of said Compound XX or said cyanoacetamide of the first aspect for decreasing aldehyde, for example formaldehyde, content in a polyoxymethylene (POM) polymer and/or for increasing Oxidative Induction Time (OIT) in POM and/or increasing thermal stability of POM.

According to a third aspect of the invention, there is provided a polyoxymethylene (POM) polymer, having a reduced level of aldehyde and/or increased Oxidative Induction Time (OIT) and/or increased thermal stability, said POM polymer incorporating an aldehyde scavenger according to the first aspect or a product of a reaction between an aldehyde scavenger according to the first aspect and aldehyde.

Said POM polymer preferably includes 2 ppm or less of aldehyde when assessed according to VDA-275. Said POM polymer suitably has an improved thermal stability and/or an increased OIT which may be illustrated as described in Assessment 3.

Said POM polymer preferably includes residual carrier as described according to the first aspect.

Said POM polymer preferably includes anti-oxidant as described according to the first aspect.

Said POM polymer may be in pellet form.

A formulation as described may be used in the manufacture of parts or in the manufacture of pellets, for example masterbatch pellets, which may be used in subsequent manufacture of parts. Thus, according to a fourth aspect of the invention, there is provided a method of making an article, for example a shaped article, or pellets from a polyoxymethylene (POM) polymer, the method comprising:
(a) selecting a formulation comprises a carrier and an aldehyde scavenger as described in the first aspect and/or second aspects;
(b) contacting the POM polymer with said formulation; and
(c) forming said POM polymer into an article, for example a shaped article or into pellets.

Said article or pellets preferably includes 2 ppm or less of aldehyde when assessed according to VDA-275. Said article or pellets polymer suitably have an improved thermal stability and/or an increased OIT which may be illustrated as described in Assessment 3.

Preferably, in step (c), the POM polymer is suitably melt-processed to define said article or pellets.

Said article or pellets may be defined by any process known in the art. For example, said process may comprise injection molding, blow molding, thermoforming or extrusion.

Said article or pellets may include one or more colourants and may include 5-500 ppm of a colourant, for example when an article is made. The aforementioned ppm is suitably based on the amount of said POM polymer. A said colourant described herein may be a dye or pigment.

When pellets are made, the pellets may include up to 60 wt % of colourant, for example titanium dioxide. Such pellets may define a masterbatch which suitably includes 5 to 35 wt % fillers, for example colourants, suitably as described.

Preferably, in said shaped article, the sum of the wt % of one or more POM polymer(s), and the aldehyde scavenger is at least 90 wt %, at least 95 wt % or at least 98 wt %.

According to a fifth aspect of the invention, there is provided an article or pellet having a reduced level of aldehyde and/or an improved thermal stability and/or an increased OIT, said article or pellet being made as described in the fourth aspect and/or comprising POM polymer and a said aldehyde scavenger as described.

Said article or pellet preferably includes 2 ppm or less of aldehyde when assessed according to VDA-275. Said article or pellet suitably has an improved thermal stability and/or an increased OIT which may be illustrated as described in Assessment 3.

Any aspect of any invention described herein may be combined with any other aspect of any invention described herein mutatis mutandis.

Specific embodiments of the invention will now be described by way of example.

The following materials are referred to hereinafter:
2-cyanoacetamide—a commercially-available product obtained from Fisher Scientific;
Irganox 1010—commercially-available pentaerythritol tetrakis(3,5-di-tert-butyl-4-hydroxyhydrocinnamate) obtained from Sigma Aldrich;
Carrier A—refers to Clearslip™ 2 available from ColorMatrix. Carrier A was selected to have good solubility in the POM co-polymer used.
Co-polymer POM—refers to Ultraform S2320 POM co-polymer obtained from BASF;
Iupital POM—refers to Iupital™ F20-03 POM co-polymer.
   Assessment 1—General procedure for determining formaldehyde content of plaques

The formaldehyde content of samples is determined on injection moulded plaques (40×100×3 mm (W×L×D)). The level of formaldehyde is determined using a Markes Micro-Chamber/Thermal Extractor™ (p-CTE™). The device is a versatile and compact unit with up to four small cylindrical chambers that enables the sampling of chemicals released from products or materials. Released volatile and semi-volatile organic compounds (VOCs and SVOCs) are collected in cartridges containing 2,4-dinitrophenylhydrazine for analysis by HPLC in accordance with ISO 16000-3. Formaldehyde reductions are calculated on the basis of percentage reduction seen in the formaldehyde levels of a part with additives, compared to a reference part that did not contain the additive. The assessment described has been shown to be comparable to VDA-275 which is an automotive standard formaldehyde test.

Assessment 2—Procedure for measuring optical properties

Plaques (sizes 95×165×3 mm (W×L×D)) made in a manner similar to that described below and relevant controls were made and optical properties (i.e. L*, a* and b*) were assessed using a Minolta CM-3700d spectrophotometer in transmission mode fitted with a D65/10° light source.

| Polymer | Ultraform S2320 |
|---|---|
| Machine name | Engel ES 330/70 HL |
| Zone 3 temp. (° C.) | 190 |
| Zone 2 temp. (° C.) | 190 |
| Zone 1 temp. (° C.) | 190 |
| Nozzle temp. (° C.) | 200 |
| Mold temp. (° C.) | 50 |

Assessment 3—Oxidative induction time testing

Oxidation induction time (OIT) tests were conducted using a heat-flux differential scanning calorimetry (DSC) to analyse the thermal stability of POM samples. Samples of about 5-6 mg were heated from room temperature to 230° C. under a flow of nitrogen gas (50 ml/min) and held for 5 minutes. The gas flow was switched to oxygen (50 ml/min) and held constant to investigate the induction time. The peak maximum and not the onset temperature of the OIT response will be taken as the OIT results as observation shows that it is difficult to determine a well-defined onset temperature, as discussed in V. Archodoulaki, S. Luftl and S. Seidler, “Oxidation induction time studies on the thermal degradation behaviour of polyoxymethylene”, Polymer Testing, vol. 25, no. 1, pp. 83-90, 2006.

### EXAMPLE 1—PREPARATION OF ACETALDEHYDE SCAVENGER N,N′-(2-(4-(2-AMINOBENZAMIDO)BUTYL)PENTANE-1,5-DIYL)BIS(2-AMINOBENZAMIDE) (REFERRED TO AS COMPOUND X)

Compound X has the following structure.

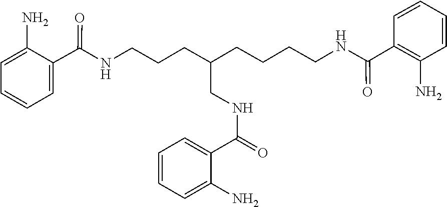 [SMILES: Nc1ccccc1C(=O)NCCCCC(CCCNC(=O)c1ccccc1N)CNC(=O)c1ccccc1N]

2H-benzo[d][1,3]oxazine-2,4(1H)-dione (98.84 g, 3.5 Eq, 605.9 mmol) was dissolved in dimethylformamide (500 ml) at room temperature. To the reaction mixture was drop-wise added a solution of 4-(aminomethyl)octane-1,8-diamine (30.00 g, 1 Eq, 173.1 mmol) in dimethylformamide (250 ml). The reaction mixture was stirred at room temperature overnight until full conversion was evidenced by LC-MS. The dimethylformamide was removed under reduced pressure yielding a dark brown oil. To this was added water (1 I), ammonium hydroxide (25%, 50 ml) and the product extracted with dichloromethane. The dichloromethane was removed under reduced pressure and the product recrystallized in a mixture of methanol and acetonitrile. The solids were collected by filtration and dried to yield N,N′-(2-(4-(2-aminobenzamido)butyl)pentane-1,5-diyl)bis(2-aminobenzamide) (51.0 g, 55.5% yield). The structure of the compound was confirmed by NMR and LC-MS and the melting point was 160° C.

### EXAMPLE 2—GENERAL PROCEDURE FOR PREPARING SOLID FORMULATIONS

Solid Masterbatch formulations were prepared by the blending of the required amounts of base polymer, formaldehyde reducing agent and optional antioxidant stabilizer in a twin screw extruder. Pellets were cut using a strand cutter. The materials were prepared using a Labtech LTE444-16 twin-screw extruder using the following conditions

| | |
|---|---|
| Screw speed (rpm) | 300 |
| Feed rate (kg/h) | 3 |
| Screw ratio | 44:1 |
| Zone 1 (° C.) | 80 |
| Zone 2 (° C.) | 175 |
| Zone 3 (° C.) | 190 |
| Zone 4 (° C.) | 200 |
| Zone 5 (° C.) | 200 |
| Zone 6 (° C.) | 200 |
| Zone 7 (° C.) | 200 |
| Zone 8 (° C.) | 185 |
| Zone 9 (° C.) | 180 |
| Zone 10 (° C.) | 190 |

Example 3—General procedure for preparing liquid formulations Liquid formulations were prepared by combining the liquid Carrier A and optional dispersant (Solplus K240 (Poly(12-hydroxystearic acid)-polyethyleneimine copolymer; CAS number 124578-12-7) in a liquid mixing vessel. To this was added the aldehyde scavenging agent and optional antioxidant. The formulation may be milled to yield desirable particle sizes. Rheology modifiers may be optionally added. The formulation was mixed under vacuum to remove any residual air.

### EXAMPLE 4—OXIDATIVE INDUCTION TIME (OIT) TESTING OF 2-CYANOACETAMIDE AND COMPOUND X FORMULATIONS AND COMPARISON TO PRIOR ART FORMALDEHYDE SCAVENGERS FOR POM

Technologies identified in the prior art were extruded in Iupital POM and compared to use of 4-cyanoacetamide and Compound X in terms of formaldehyde emissions and OIT. In each case, anti-oxidant (Irganox 1010) was fixed at 0.3%. Results are provided in the table below.

| Formaldehyde | Loading | Formaldehyde | |
|---|---|---|---|
| Scavenger | scavenger (%) | emission (ppm) | OIT mins |
| None | — | 72.0 | 45.85 |
| Adipic dihydrazide | 0.6 | 11.2 | 44.35 |
| Benzoguanamine | 0.6 | 15.5 | 56.9 |
| Hydantoin | 0.6 | 12.7 | 45.24 |
| Allantoin | 0.6 | 6.8 | 41.45 |
| Terephthalic dihydride | 0.6 | 9.5 | 49.51 |
| Compound X | 0.6 | 4.7 | 64.2 |
| Cyanoacetamide | 0.3 | 5.3 | 51.73 |

The results show that respective uses of Compound X and 2-cyanoacetamide both result in very low formaldehyde emissions in POM coupled with high OIT. It should be noted that cyanoacetamide offers high levels of formaldehyde reduction with only 50% of the addition level compared to other scavengers. In addition, it is known that OIT corelates with the concentration of anti-oxidant present in the POM polymer. A synergistic benefit was observed with combinations of Compound X or cyanoacetamide together with anti-oxidant.

It is concluded from the above that both Compound X and cyanoacetamide provide improvements and/or are advantageous compared to the prior art referenced.

### EXAMPLE 5—PREPARATION OF SOLID AND LIQUID FORMULATIONS COMPRISING COMPOUND X

Following the procedures described in Examples 2 and 3, solid and liquid formulations comprising Compound X were prepared having the compositions detailed in the table below.

In the following, the aldehyde scavenger (AS) component was Compound X, the anti-oxidant was Irganox 1010, the liquid carrier for Formulation No. VIII was Carrier A and the solid carrier for Formulation No. VII was Co-polymer POM.

| | Amount of | anti- | |
|---|---|---|---|
| Formulation | AS Component | oxidant | Carrier |
| No. | (wt %) | (wt %) | (wt %) |
| VII | 8 | 1.33 | 90.67 |
| VIII | 20 | 3.33 | 76.67 |

### EXAMPLES 6 AND 7—ASSESSMENT OF SOLID AND LIQUID FORMULATIONS COMPRISING COMPOUND X

Solid and liquid formulations VII and VIII were added to Ultraform S2320 POM co-polymer and plaques produced by injection moulding at the let-down-ratios (LDRs) as described in the table below. The formaldehyde emissions were assessed as described in Assessment 1 and the L*, a* (D65), b* (D65) were assessed as described in Assessment 2.

| | | | wt % | Formaldehyde | | | |
|---|---|---|---|---|---|---|---|
| | | | Compound | emissions | | | |
| Example | Formulation | LDR | X in | ISO:16003 | L* | a* | b* |
| No. | used | % | plaque | (ppm) | (65) | (D65) | (D65) |
| 6 | VII (solid | 3.75 | 0.3 | 3.11 | 91.7 | 0.11 | 8.63 |
| | MB) | | | | | | |
| 7 | VIII (liquid) | 0.88 | 0.18 | 1.05 | 94.14 | 0.13 | 2.77 |
| Control | — | — | 0 | 77.5 | 95.63 | −0.44 | 0.24 |

The control refers to CoPolymer POM with no additives.

Both the solid masterbatch and the liquid formulation provided a significant formaldehyde reduction coupled with reduced discoloration with a low addition level. In addition, no discernible differences in oxidation induction time between formulation options were observed—both had an advantageous effect on OIT as described in Example 4.

### EXAMPLE 8—PREPARATION OF SOLID AND LIQUID FORMULATIONS COMPRISING 2-CYANOACETAMIDE

Following the procedures described in Examples 2 and 3, solid and liquid formulations comprising cyanoacetamide were prepared having the compositions detailed in the table below. In the following, the aldehyde scavenger (AS) component was 2-cyanoacetamide, the anti-oxidant was Irganox 1010, the liquid carrier for Formulation No. X was Carrier A and the solid carrier for Formulation No. IX was Co-polymer POM.

| | Amount of | anti- | | Amount of |
|---|---|---|---|---|
| Formulation | AS Component | oxidant | Carrier | fumed silica |
| No. | (wt %) | (wt %) | (wt %) | (wt %) |
| IX | 12 | 4 | 84 | 0 |
| X | 35 | 5.83 | 58.17 | 1 |

### EXAMPLES 9 AND 10—ASSESSMENT OF SOLID AND LIQUID FORMULATIONS COMPRISING 2-CYANOACETAMIDE

Solid and liquid formulations IX and X were added to Ultraform S2320 POM co-polymer and plaques produced by injection moulding at the let-down-ratios (LDRs) as described in the table below. The formaldehyde emissions were assessed as described in Assessment 1 and the L*, a* (D65), b* (D65) were assessed as described in Assessment 2.

| | | | | Formaldehyde | | | |
|---|---|---|---|---|---|---|---|
| | | | wt % | emissions | | | |
| Example | Formulation | LDR | cyanoacetamide | ISO:16003 | L* | a* | b* |
| No. | used | % | in plaque | (ppm) | (65) | (D65) | (D65) |
| 9 | IX (solid MB) | 1.56 | 0.19 | 2.60 | 94.52 | −5.44 | 18.82 |
| 10 | X (liquid) | 0.27 | 0.09 | 1.57 | 95.23 | −2.79 | 7.41 |
| Control | — | — | 0 | 77.5 | 95.63 | −0.44 | 0.24 |

The control refers to CoPolymer POM with no additives.

Both the solid masterbatch and the liquid formulation provided a significant formaldehyde reduction coupled with reduced discoloration with a low addition level. In addition, no discernible differences in oxidation induction time between formulation options were observed—both had an advantageous effect on OIT as described in Example 4.

### EXAMPLES 11 TO 15—USE OF COMPOUND X AS ALDEHYDE SCAVENGER AND SYNERGISTIC IMPACT OF FORMULATION COMPONENTS ON FORMALDEHYDE EMISSIONS

Following the procedure generally described for examples 6 and 7, individual components or mixtures of components included in the liquid formulations described were dosed into copolymer POM at the levels indicated and then assessed to determine the individual and/or collective effect on formaldehyde emissions and optical properties. Details of components and mixtures assessed and results are provided in the table below.

Where a carrier and an anti-oxidant were used, the components were Carrier A and Irganox 1010 respectively.

| | | Formaldehyde | | | |
|---|---|---|---|---|---|
| | | emissions | | | |
| Example | Additives (and amount(s) | ISO: 16003 | | | |
| No. | introduced into co-polymer POM) | (ppm) | L* | a* | b* |
| 11 | Carrier A (1.2 wt %) | 47.24 | 95.16 | −0.5 | 0.51 |
| 12 | Anti-oxidant (0.05 wt %) | 59.98 | 95.64 | −0.48 | 0.5 |
| 13 | Compound X (0.39%) + Carrier A | 0.13 | 88.61 | 2.56 | 8.62 |
| | (1.2 wt %) | | | | |
| 14 | Compound X (0.39 wt %) + Anti- | 0.33 | 90.37 | 1.82 | 6.98 |
| | oxidant (0.05 wt %) | | | | |
| 15 | Compound X (0.39 wt %) + Anti- | <0.10 | 88.77 | 2.53 | 8.45 |
| | oxidant (0.05 wt %) + Carrier A | | | | |
| | (1.2 wt %) | | | | |

### EXAMPLES 16 TO 20—USE OF CYANOACETAMIDE AS ALDEHYDE SCAVENGER AND SYNERGISTIC IMPACT OF FORMULATION COMPONENTS ON FORMALDEHYDE EMISSIONS

Following the procedure generally described for examples 6 and 7, individual components or mixtures of components included in the liquid formulations described were dosed into copolymer POM at the levels indicated and then assessed to determine the individual and/or collective effect on formaldehyde emissions and optical properties. Details of components and mixtures assessed and results are provided in the table below.

Where a carrier and an anti-oxidant were used, the components were Carrier A and Irganox 1010 respectively.

| | | Formaldehyde | | | |
|---|---|---|---|---|---|
| | | emissions | | | |
| Example | Additives (and amount(s) | ISO: 16003 | | | |
| No. | introduced into co-polymer POM) | (ppm) | L* | a* | b* |
| 16 | Carrier A (1.2 wt %) | 47.24 | 95.16 | −0.5 | 0.51 |
| 17 | Anti-oxidant (0.05 wt %) | 59.98 | 95.64 | −0.48 | 0.5 |
| 18 | Cyanoacetamide (0.15%) + Carrier A | 9.80 | 93.28 | 1.81 | 6.5 |
| | (1.2 wt %) | | | | |
| 19 | Cyanoacetamide (0.15 wt %) + Anti- | 5.97 | 93.32 | −1.63 | 5.97 |
| | oxidant (0.05 wt %) | | | | |
| 20 | Cyanoacetamide (0.15 wt %) + Anti- | 1.20 | 94.99 | 0.12 | 6.14 |
| | oxidant (0.05 wt %) + Carrier A | | | | |
| | (1.2 wt %) | | | | |

For POM formulations, a wide range of materials may be incorporated into the formulations, including stabilisers such as hindered amine light stabilizers (HALS); acid scavengers eg calcium stearate, hydrotalcite; lubricants: eg waxes; BaSO₄, TiO₂, carbon black, pigments, aromatic polyamide, silicon powder, polytetrafluoroethylene and UV stabilisers.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of decreasing aldehyde content in a polyoxymethylene (POM) polymer and/or increasing Oxidative Induction Time (OIT) and/or increasing thermal stability, the method comprising the step of contacting the POM polymer, or monomers, oligomers or pre-polymers involved in the preparation of said POM polymer, with an aldehyde scavenger selected from:
(i) a compound XX which includes at least three moieties of formula 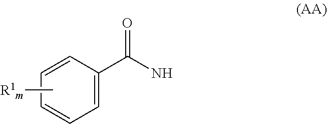
wherein each moiety (AA) includes an amine moiety (—NH₂) bonded ortho or meta to the amide moiety (—CONH);
wherein each R¹ independently represents a substituent and m is an integer from 0 to 4; and
wherein the three moieties (AA) are bonded, via their respective amide nitrogen atoms, to respective carbon atoms of a Main Fragment, wherein the Main Fragment includes carbon and hydrogen atoms only and is saturated; and
(ii) a cyanoacetamide.

2. A method according to claim 1, wherein said POM is a homopolymer POM or a copolymer POM.

3. A method according to claim 1, wherein said aldehyde scavenger is a compound XX, wherein:
one or each R¹ is an optionally-substituted alkyl group;
one or each m is 0 or 1;
at least one moiety (AA) includes an amine moiety (—NH₂) bonded ortho to the amide moiety (—CONH);
said Main Fragment does not include any cyclic or aromatic moiety; and
said Main Fragment comprises a linear or branched chain.

4. A method according to claim 1 wherein said Main Fragment is of general formula 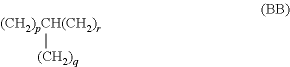
wherein p, q and r are integers, suitably in the range 1 to 10.

5. A method according to claim 4, wherein the sum of integers p, g and r is at least 4 and is less than 20 and, in compound XX, the nitrogen atoms of the amide moieties (—CONH) are spaced apart by at least 2 carbon atoms and by no more than 10 carbon atoms.

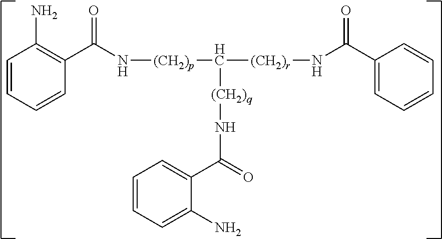

6. A method according to claim 1, wherein said cyanoacetamide is of general formula 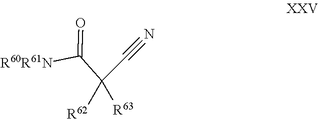
wherein R⁶⁰ and R⁶¹ independently represent a hydrogen atom or an optionally-substituted, preferably unsubstituted, alkyl, cycloalkyl or aromatic group; and

7. A method according to claim 6, wherein R⁶² and R⁶³ independently represent a hydrogen atom or an optionally-substituted, preferably unsubstituted, alkyl, cycloalkyl or aromatic group.

8. A method according to claim 6, wherein R⁶⁰ and R⁶¹ independently represent a hydrogen atom or an unsubstituted alkyl or cycloalkyl group and R⁶² independently represent a hydrogen atom or an unsubstituted alkyl or cycloalkyl group.

9. A method according to claim 6, wherein R⁶⁰, R⁶¹, R⁶² and R⁶³ each represent hydrogen atoms.

10. A method according to claim 1, wherein said aldehyde scavenger is part of a formulation which is contacted with the POM polymer, wherein said formulation is selected from:
a solid masterbatch formulation, wherein said formula includes 10-40 wt % of said aldehyde scavenger and 60-90 wt % of thermoplastic polymer, for example POM; and
a liquid formulation comprising 50 to 90 wt % of liquid carrier and 10 to 50 wt % of said aldehyde scavenger.

11. A method according to claim 10, wherein said formulation includes 0.5 to 10 wt % of an anti-oxidant.

12. (canceled)

13. A method according to claim 11, wherein said anti-oxidant is of formula 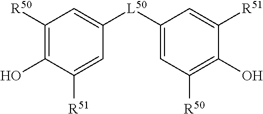
wherein L⁵⁰ is a linking moiety which includes an oxyalkylene moiety and one or more ester moieties.

14. A method according to claim 1, wherein said method decreases aldehyde content in the POM polymer so the POM polymer includes 2 ppm or less of aldehyde when assessed according to VDA-275.

15. A method according to claim 1, said method being a method of increasing Oxidative Induction Time (OIT).

16. (canceled)

17. A polyoxymethylene (POM) polymer, having a reduced level of aldehyde and/or increased Oxidative Induction Time (OIT) and/or increased thermal stability, said POM polymer incorporating an aldehyde scavenger according to claim 1 or a product of a reaction between an aldehyde scavenger according to claim 1 and aldehyde, wherein said POM polymer includes 2 ppm or less of aldehyde when assessed according to VDA-275; and said POM polymer is in pellet form.

18. (canceled)

19. (canceled)

20. A method of making an article or pellets from a polyoxymethylene (POM) polymer, the method comprising:
(a) selecting a formulation comprising a carrier and an aldehyde scavenger as described in claim 17;
(b) contacting the POM polymer with said formulation; and
(c) forming said POM polymer into an article, for example a shaped article or into pellets.

21. A method according to claim 20, wherein:
said article or pellets include 2 ppm or less of aldehyde when assessed according to VDA-275; and/or said article or pellets have an improved thermal stability;
and/or an increased OIT.

22. (canceled)

23. (canceled)

24. A method according to claim 1, wherein said aldehyde scavenger is part of a liquid formulation comprising 50 to 90 wt % of liquid carrier and 10 to 50 wt % of said aldehyde scavenger.

25. A method according to claim 2, wherein said aldehyde scavenger is a compound XX, wherein:
one or each R¹ is an optionally-substituted alkyl group;
one or each m is 0 or 1;
at least one moiety (AA) includes an amine moiety (—NH₂) bonded ortho to the amide moiety (—CONH);
said Main Fragment is of general formula 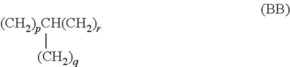
wherein p, q and r are integers in the range 1 to 10.

26. A method according to claim 25, wherein said aldehyde scavenger is part of a formulation which is contacted with the POM polymer, wherein said formulation is a liquid formulation comprising 50 to 90 wt % of liquid carrier and 10 to 50 wt % of said aldehyde scavenger.
